(19) United States
(12) Patent Application Publication
(10) Pub. No.: US 2006/0038913 A1
(43) Pub. Date: Feb. 23, 2006

(54) Optical zoom apparatus and portable communication apparatus using the same

(75) Inventors: Doo-Sik Shin, Suwon-si (KR); Young-Kwon Yoon, Anyang-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/140,123

(22) Filed: May 27, 2005

(30) Foreign Application Priority Data
Aug. 23, 2004 (KR) 2004-66293

(51) Int. Cl. H04N 5/225

(52) U.S. Cl. 348/360

(57) ABSTRACT

An optical zoom apparatus comprises a plurality of lenses; a lens housing for retaining the corresponding lenses; a first magnetic body positioned around the lens housing; a second magnetic body positioned around the lens housing along a movement axis while being spaced from the first magnetic body; and a movement means positioned between the first and second magnetic bodies while surrounding the lens housing to move the lens housing back and forth along the movement axis as an electric current is applied.

### CLAIM OF PRIORITY

This application claims priority to an application entitled “Optical Zoom Apparatus and Portable Communication Apparatus Using the Same,” filed with the Korean Intellectual Property Office on Aug. 23, 2004 and assigned Ser. No. 2004-66293, the contents of which are hereby incorporated by reference.

### BACKGROUND OF THE INVENTION

1. Field of the Invention

The present invention relates to a portable communication apparatus, and more particularly to a portable communication apparatus which is particularly compact or slim even when an optical zoom camera lens module is mounted on the body.

2. Description of the Related Art

In general, a “portable communication apparatus” refers to an electronic apparatus that a user can carry with him to perform wireless communication. In consideration of portability, designs of such portable communication apparatuses have tended not only toward compactness, slimness, and lightness, but also toward multimedia availability, having a wider variety of functions. Future portable communication apparatuses are expected to incorporate greater multi-functionality and multi-purpose utilization, as well as greater compactness and lightness. They will also be modified for various multimedia environments or Internet environments. Additionally, such portable communication apparatuses are now commonly used by people of all ages and all walks of life throughout the world. Moreover, they are recognized by some people as a nearly indispensable commodity which must always be carried with one.

Conventional portable communication apparatuses may be classified into various types according to their appearance, such as bar-type portable communication apparatuses, flip-type portable communication apparatuses, and folder-type portable communication apparatuses. The bar-type portable communication apparatuses have a single housing shaped like a bar. The flip-type portable communication apparatuses have a flip which is rotatably connected to a bar-shaped housing by a hinge device. The folder-type portable communication apparatuses have a folder coupled to a single bar-shaped housing by a hinge device in such a manner that the folder can be rotated in order to be folded to or unfolded from the housing.

Additionally, portable communication apparatuses may be classified into rotation-type communication apparatuses and sliding-type communication apparatuses according to the way they open and close. In the rotation-type communication apparatuses, two housings are connected to each other in such a manner that one housing rotates when opened or closed relative to the other while they face each other. In the sliding-type communication apparatuses, two housings are connected to each other in such a manner that one housing slides along a longitudinal direction when opened or closed relative to the other. These variously classified portable communication apparatuses are well known to those skilled in the art.

Meanwhile, conventional portable communication apparatuses now tend to transmit data at a high speed in addition to the basic function of performing voice communication. In other words, according to the increase of demand by consumers, portable communication apparatuses now tend to provide a service, using a wireless communication technology, capable of transmitting data at a high speed.

Additionally, conventional portable communication apparatuses are now equipped with a camera lens to transmit video signals. Portable communication apparatuses generally have an external or embedded camera lens module to perform video communication or to take pictures of a desired object. Portable communication apparatuses that have an optical zoom camera lens module have also been proposed.

When an optical zoom apparatus is applied to an optical zoom camera lens module, a mechanical structure such as a stepping motor or an apparatus using a piezoelectric phenomenon has been proposed. An example of a mechanical optical zoom apparatus using a stepping motor is disclosed in detail in U.S. Pat. No. 6,762,888 to Ohima et al., entitled “Control system of zoom lens for digital still cameras” (the contents of which are hereby incorporated by reference).

Portable communication apparatuses are electronic apparatuses driven by electrically charged batteries and are carried by individuals. Accordingly, power consumption, volume, and convenience are considered as important factors.

However, when conventional optical zoom apparatuses are mounted on the body of portable wireless terminals, the body must have at least a predetermined thickness. Specifically, when the body is provided with a camera lens module using an optical zoom principle, the optical zoom distance of the camera lens must be considered when determining the thickness of the body. This adversely affects the compactness and slimness of portable communication apparatuses.

Furthermore, optical zoom apparatuses that use stepping motors unavoidably have noise and vibration and are unsuitable for slimness. In an effort to solve the above problems, an optical zoom apparatus using a piezoelectric phenomenon has been proposed. However, such an optical zoom apparatus has the problem of unstable zoom operation and increased power consumption.

### SUMMARY OF THE INVENTION

Accordingly, the present invention has been made to reduce or overcome the above-mentioned problems occurring in the prior art and provides additional advantages, by providing an optical zoom apparatus that is slim in size and operates in a stable manner with less power consumption.

In accordance with the principles of the present invention, an optical zoom apparatus is provided comprising a plurality of lenses; a lens housing for retaining the corresponding lenses; a first magnetic body positioned near the lens housing; a second magnetic body positioned near the lens housing along a movement axis while being spaced from the first magnetic body; and a movement means positioned between the first and second magnetic bodies to move the lens housing long the movement axis as an electric current is applied.

### BRIEF DESCRIPTION OF THE DRAWINGS

The present invention will be more apparent from the following detailed description taken in conjunction with the accompanying drawings, in which:

FIG. 1 is a sectional view of an optical zoom apparatus according to a first embodiment of the present invention;

FIG. 2 is a perspective view of the optical zoom apparatus shown in FIG. 1;

FIG. 3 is a top view of a movement means shown in FIG. 1;

FIG. 4 is a perspective view of a movement means shown in FIG. 1;

FIG. 5 is a partially enlarged view of a portion of the movement means shown in FIG. 3;

FIG. 6 is a lateral view of a movement means shown in FIG. 1;

FIG. 7 is a perspective view of a lens housing shown in FIG. 1;

FIG. 8 shows a portable communication apparatus comprising an optical zoom apparatus according to a second embodiment of the present invention;

FIG. 9 is a sectional view of the optical zoom apparatus shown in FIG. 8; and

FIG. 10 is a graph illustrating the operation of the optical zoom apparatus shown in FIG. 9.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

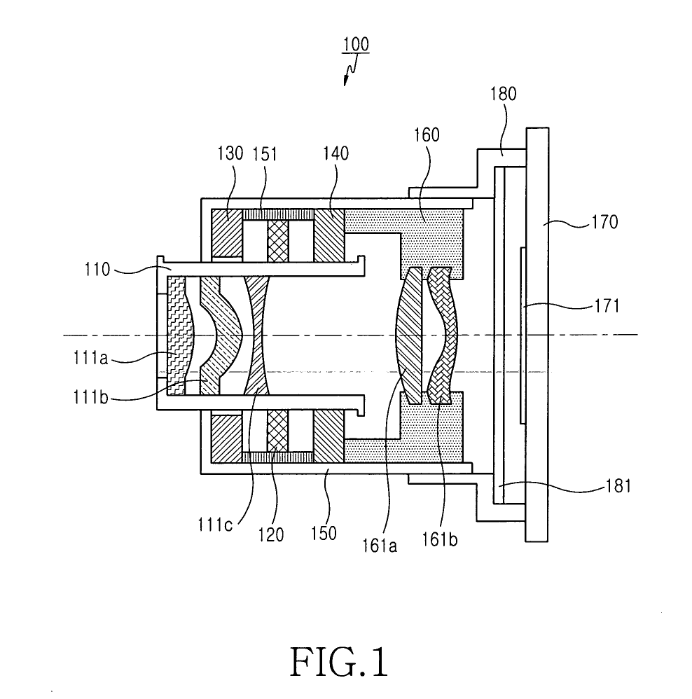

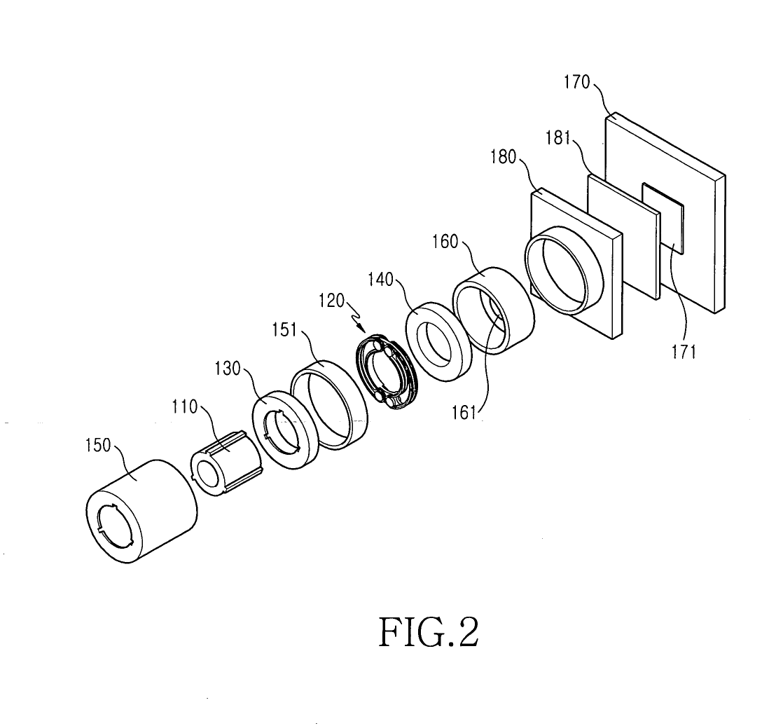

FIG. 1 is a sectional view of an optical zoom apparatus according to a first embodiment of the present invention. FIG. 2 is a perspective view of the optical zoom apparatus shown in FIG. 1. Referring to both FIGS. 1 and 2, an optical zoom apparatus 100 according to a first embodiment of the present invention comprises a plurality of lenses 111a, 111b, 111c, 161a, and 161b; a lens housing 110 for retaining the corresponding lens 111a, 111b, and 111c; a first magnetic body 130; a second magnetic body 140 spaced from the first magnetic body 130; a movement means 120 positioned between the first and second magnetic bodies 130 and 140 while surrounding the lens housing 110 to move the lens housing 110 back and forth along a movement axis as an electric current is applied; an external housing 150; an image sensor 171; a UV filter 181; a circuit board 170; an optical tube 160; and a support member 180.

The image sensor 171 detects optical signals inputted through the lenses 111a, 111b, 111c, 161a, and 161b. The UV filter 181 interrupts UV rays of the inputted optical signals. The circuit board 170 detects optical signals into electric signals. The optical tube 160 is mounted in the external housing 150 and retains the lenses 161a and 161b which are not retained by the lens housing 110. The support member 180 has an end on which the circuit board 170 is seated and the other end into which the external housing 150 is inserted and retained.

The first and second magnetic bodies 130 and 140 have a radial structure with a hollow formed at the center thereof along the movement axis. The lens housing 110 passes through each hollow of the first and second magnetic bodies 130 and 140 with a predetermined spacing. Surfaces of the first and second magnetic bodies 130 and 140, which face each other, have the same polarity and forms a magnetic field between the first and second magnetic bodies 130 and 140. The first and second magnetic bodies 130 and 140 may comprise a permanent magnet or a solenoid.

The external housing 150 has a cylindrical shape with a hollow extending through the center thereof along the movement axis. The first and second magnetic bodies 130 and 140 are supported on the inner peripheral surface of the external housing 150.

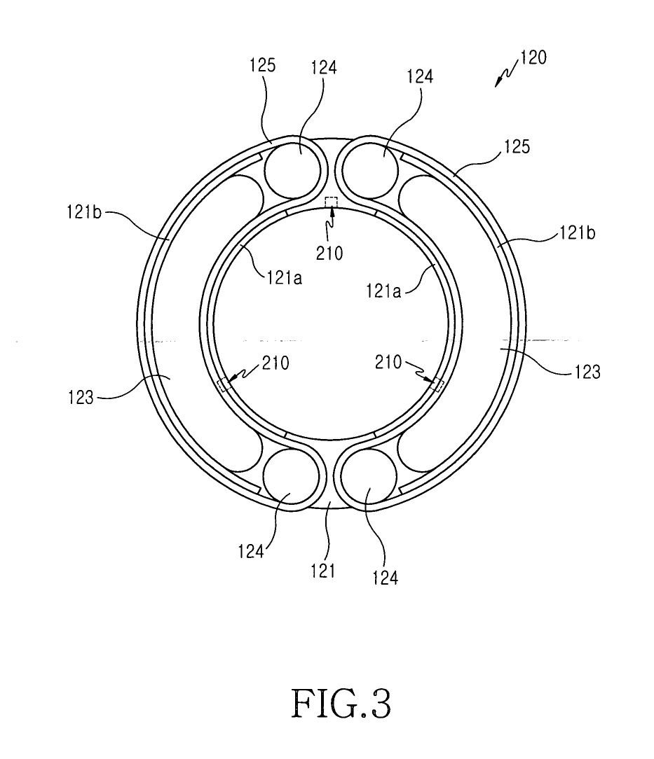

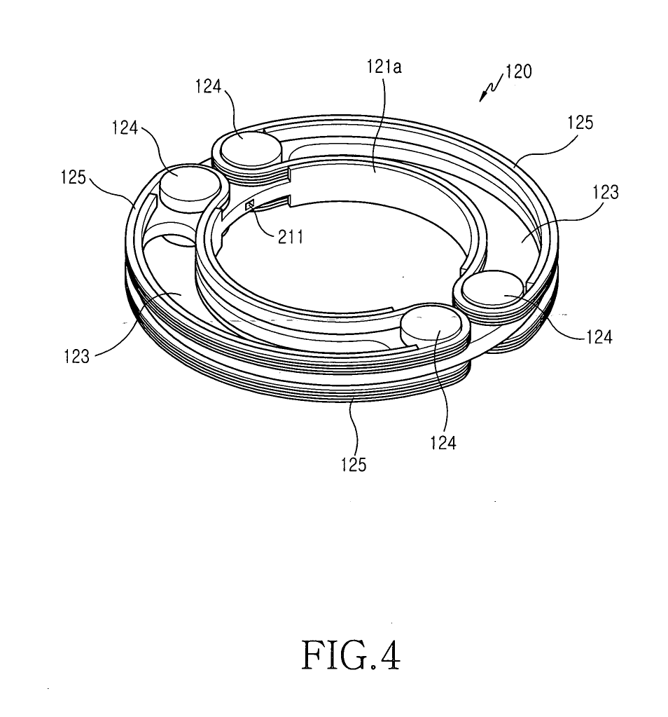

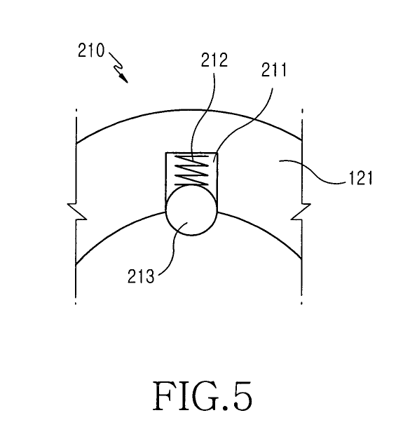

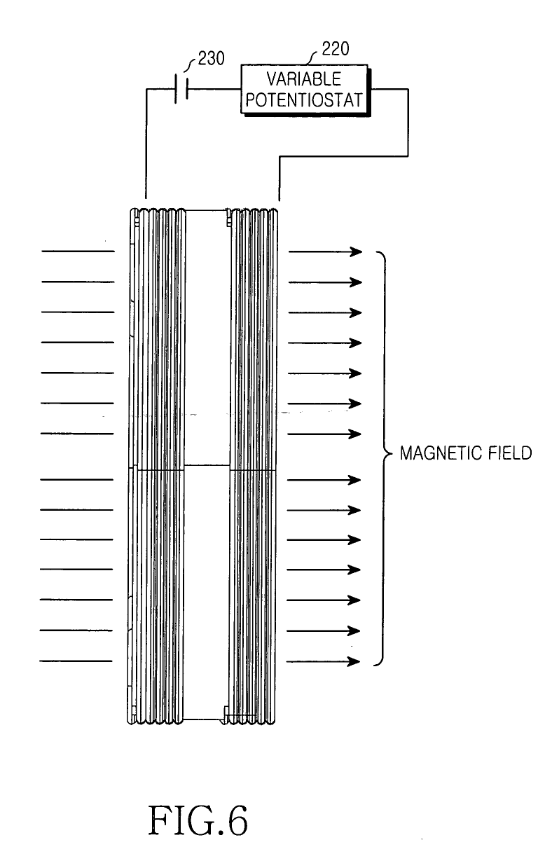

FIGS. 3 to 6 show the structure of the movement means 120 shown in FIG. 1. Referring to FIGS. 3 to 6, the movement means 120 comprises a nonmagnetic body 121 having a hollow extending through the center thereof and a plurality of coil groups 125 surrounding the outer peripheral surface of the nonmagnetic body 121. The movement means is connected to a DC power 230 for supplying a direct current and to a variable potentiostat 220 for controlling the intensity and direction of the direct current.

The nonmagnetic body 121 comprises a plurality of C-grooves 123 extending along the movement axis around the hollow formed at the center thereof; a plurality of guide blades 121a and 121b extending in a direction parallel to the movement axis along the periphery of the C-grooves 123; a plurality of protrusions 214 extending from the nonmagnetic body 121 in a direction parallel to the movement axis between the C-grooves 123; and a plurality of guide devices 210.

The guide devices 210 comprise a guide groove 211 formed on the inner peripheral surface of the nonmagnetic body 121, an elastic means 212 inserted into the guide groove 211, and a guide ball 213 inserted into the guide groove 211 to be forced against the outer peripheral surface of the lens housing 110 by an elastic force from the elastic means 212. The guide devices 210 cause the inner peripheral surface of the nonmagnetic body 121 to engage with the outer peripheral surface of the lens housing 110 and guide the lens housing 110 to move along the movement axis. At least three guide devices 210 are provided to force the nonmagnetic body 121 against the outer peripheral surface of the lens housing 110. The guide devices 210 are spaced from one another with an interval of 120° or less.

Each coil group 125 surrounds the corresponding guide blades 121a and 121b and the corresponding protrusion 124 and forms a magnetic field when a direct current is applied. The movement means 120 may be composed of a solenoid which is capable of adjusting the direction of the magnetic field and the force according to the polarity and intensity of the applied direct current.

The movement means 120 creates a magnetic field in a predetermined direction as a direct current is applied from the DC power 230. The direction and intensity of the created magnetic field can be adjusted by controlling the polarity and intensity of the direct current with the variable potentiostat 220.

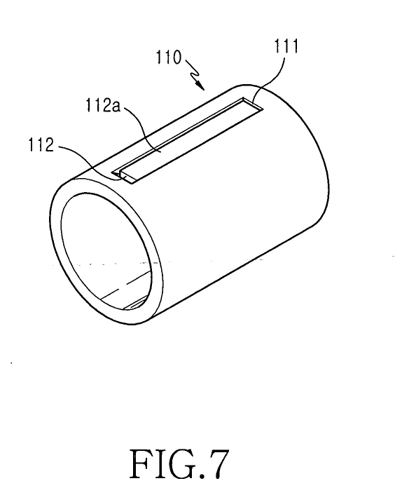

FIG. 7 is a perspective view of the lens housing 110 shown in FIG. 1. Referring to FIG. 7, the cylindrical lens housing 110 has at least one groove 111 formed on the outer peripheral surface thereof, in which a corresponding third magnetic body 112 is seated. A surface 112a of the third magnetic body 112, which faces the inner peripheral surface of the first and second magnetic bodies 130 and 140, has the same polarity with that of the inner peripheral surface of the first and second magnetic bodies 130 and 140. The first groove 111 may take the form of a strip extending along the outer peripheral surface of the lens housing 110 in a direction parallel to the movement axis or a ring extending around the outer peripheral surface of the lens housing 110.

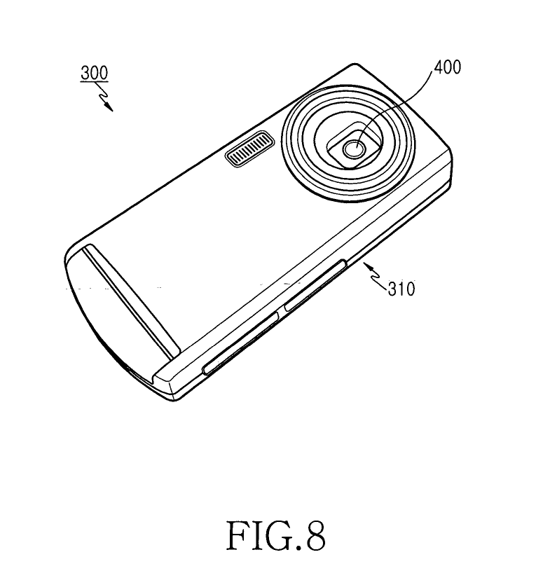

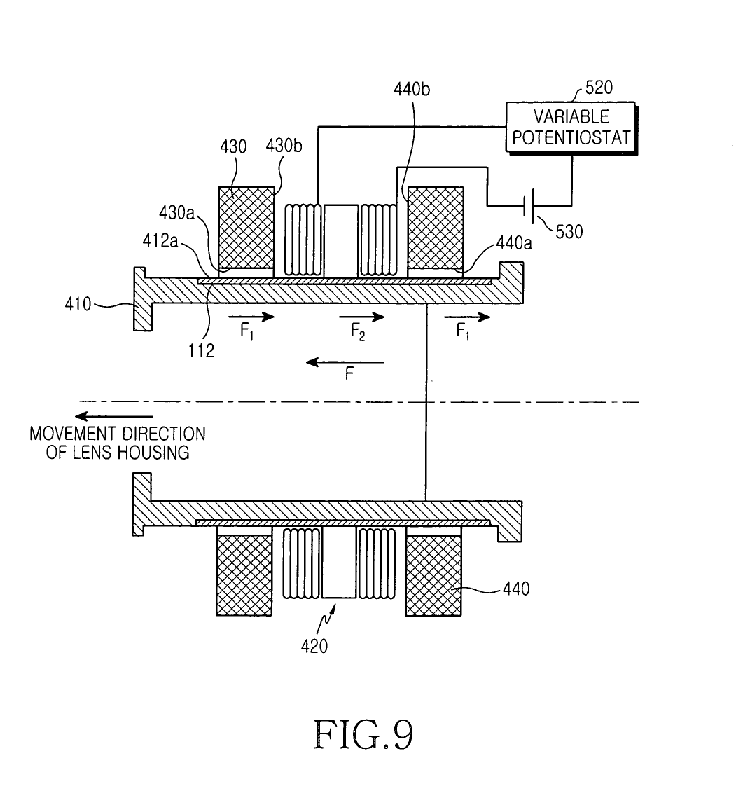

FIG. 8 is a perspective view of a portable communication apparatus according to a second embodiment of the present invention. FIG. 9 is a sectional view of an optical zoom apparatus shown in FIG. 8. Referring to FIGS. 8 and 9, a portable communication apparatus 300 according to a second embodiment of the present invention comprises an optical zoom apparatus according to the first embodiment of the present invention and a body 310.

The optical zoom apparatus 400 comprises a lens housing 410 for retaining corresponding lens (not shown); a first magnetic body 430 positioned around the lens housing 410; a second magnetic body 440 positioned around the lens housing 430 along a movement axis while being spaced from the first magnetic body 430; and a movement means 420 positioned between the first and second magnetic bodies 430 and 440 while surrounding the lens housing 410 to create a movement force for moving the lens housing 410 back and forth along the movement axis as an electric current is applied.

The lens housing 410 is aligned in such a manner that its hollow coincides with the movement axis. The second magnetic body 440, the movement means 420, and the first magnetic body 430 are successively inserted into the outer peripheral surface of the lens housing 410. Surfaces 430b and 440b of the first and second magnetic bodies 430 and 440, which face each other, have the same polarity and create a repulsive force between them. A first surface 412a of the third magnetic body 412 has the same polarity with that of inner peripheral surfaces 430a and 440a of the first and second magnetic bodies 430 and 440. The inner peripheral surfaces 430a and 440a face the first surface 412a In addition, a repulsive force is created between the first and second magnetic bodies 430 and 440 and the third magnetic body 412. The movement means 420 has a guide device (not shown) formed on the inner peripheral surface of a nonmagnetic body 421 forced against the lens housing 410. Thus, a friction force F₂ is generated between the movement means 420 and the lens housing 410. Friction forces F₁ are also generated between the first and second magnetic bodies and the lens housing.

The movement means 420 creates a movement force F in a direction parallel to the movement axis, when a direct current is applied. This provides the lens housing 410 with the movement force F. The movement force F is controlled according to the direction of the direct current applied to the movement means 420. The movement force F is transmitted to the lens housing 410 from the movement means 420 due to the friction force F₂ between the lens housing 410 and the movement means 420.

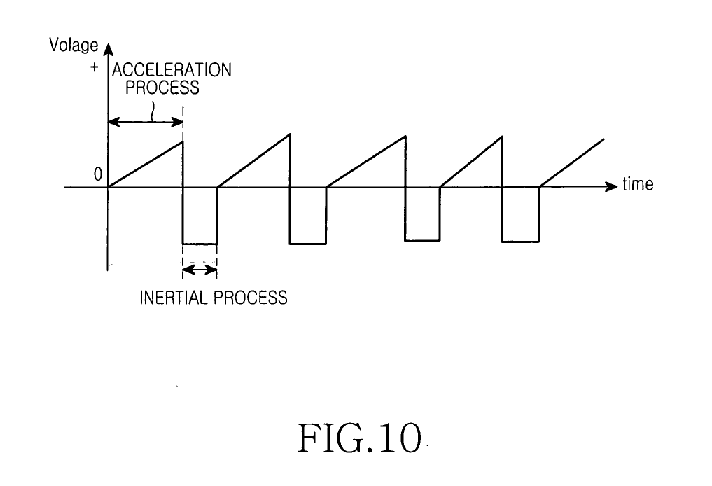

FIG. 10 is a graph illustrating the operation of the optical zoom apparatus 400 shown in FIG. 9. Referring to FIG. 10, the operation of the optical zoom apparatus 400 may be classified into acceleration processes caused by the change of direct current applied to the movement means 420 and inertial processes.

In the acceleration process, the movement force created by the movement means 420 is gradually increased and is transmitted to the lens housing 410. The movement force is proportional to the change of intensity of the direct current applied to the movement means 420.
F₂>F>2F₁ (Equation 1)

The movement means 420 is slowly accelerated, if the movement force created by the movement means 420 is larger than the friction force F₁ between the first and second magnetic bodies 430 and 440 and the lens housing 410. The lens housing 410 is also accelerated by the movement means 420. A variable potentiostat 520 controls the intensity and polarity of the direct current applied to the movement means 420 as desired.

In the inertial processes, the operation of the movement means 420 to accelerate the lens housing 410 is instantly stopped. The friction force F₂ between the lens housing 410 and the movement means 420 then disappears. Further, the lens housing 410 tends to continuously move in the direction of the transmitted movement force under the action of a stationary inertial force.

If the direct current, which has been applied to the movement means 420, is abruptly interrupted, the movement means 420 ceases to transmit a movement force to the lens housing 410. The lens housing 410 is then subject to a stationary inertial force and tends to additionally move a predetermined distance.
2F₁>F_{B}>stationary inertial force (Equation 2)

Equation 2 explains the frictional force relationship between the stationary inertial force and F₁. As the stationary movement means 420 is instantly moved F_{B} in a direction opposite to the traveling direction, the lens housing 410 is subject to a movement force F due to stationary inertia to a larger degree.

If the movement means 420 is instantly moved F_{B} in the opposite direction, the friction force F₂ between the movement means 420 and the lens housing 410 disappears and an instant slip occurs. In other words, the lens housing 410 is subject to a stationary inertial force to a larger degree, while the movement means 420 travels F_{B} in a direction opposite to the traveling direction of the movement force. As such, the movement means 420 can travel either in the direction of the applied movement force F or in a direction opposite to the traveling direction of the movement force F depending the direction of the applied direct current.

In summary, the movement means 420 plays the role of a vibrator as the direct current applied to the movement means 420 changes in the repeated acceleration and inertial processes. The vibration of the movement means 420 activates the stationary inertial force of the lens housing 410 and causes it to travel along the movement axis. The direction of vibration of the movement means 420 can be controlled by changing the polarity of the applied direct current.

As mentioned above, the optical zoom apparatus 400 comprising the movement means 420 according to the present invention uses the movement means 420 as a kind of solenoid vibrator by controlling the direct current applied to the movement means 420. If the direction of zoom operation is to be controlled, the direction of direct current in the acceleration process may be reversed.

Advantageously, the optical zoom apparatus according to the present invention can reduce noise and the product to which it is applied can be made in a slim size. Particularly, as the intensity and direction of direct current applied to the movement means is varied with a predetermined period, the movement means which is a type of solenoid is vibrated. Thus, the vibration is used to create a movement force of the lens housing. As lens housing is moved by an inertial force created by the vibration of the movement means, power consumption is minimized. Accordingly, the optical zoom apparatus can be applied to a portable communication apparatus having a slimmer size.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical zoom apparatus comprising:
a plurality of lenses;
a lens housing for retaining the plurality of lenses;
a first magnetic body positioned near the lens housing;
a second magnetic body positioned near the lens housing along a movement axis while being spaced from the first magnetic body; and
a movement means positioned between the first and second magnetic bodies to move the lens housing along the movement axis as an electric current is applied.

2. The optical zoom apparatus as claimed in claim 1, wherein the first and second magnetic bodies are positioned around the lens housing.

3. The optical zoom apparatus as claimed in claim 1, wherein the movement means surrounds the lens housing.

4. The optical zoom apparatus as claimed in claim 1, wherein the movement means move the lens housing in a back and forth movement along the movement axis.

5. The optical zoom apparatus as claimed in claim 1, wherein the lens housing has a cylindrical shape with at least one first groove formed on an outer peripheral surface, wherein a third magnetic body is positioned.

6. The optical zoom apparatus as claimed in claim 5, wherein a surface of the third magnetic body facing an inner peripheral surface of the first and second magnetic bodies has the same polarity with that of the first and second magnetic bodies.

7. The optical zoom apparatus as claimed in claim 5, wherein the first groove is formed in a radial shape along the outer peripheral surface of the lens housing at a position corresponding to that of the first and second magnetic bodies.

8. The optical zoom apparatus as claimed in claim 5, wherein the first groove is formed along the outer peripheral surface of the lens hosing in a direction parallel to the movement axis.

9. The optical zoom apparatus as claimed in claim 1, wherein the movement means has a radial shape with a hollow formed at the center, through which a long axis of the lens housing extends while coinciding with the movement axis.

10. The optical zoom apparatus as claimed in claim 9, wherein the movement means includes a nonmagnetic body and a plurality of coil around the nonmagnetic body.

11. The optical zoom apparatus as claimed in claim 10, wherein the movement means further includes a plurality of C-grooves around the periphery of the hollow along the movement axis.

12. The optical zoom apparatus as claimed in claim 11, wherein the nonmagnetic body comprises a plurality of guide devices formed on the inner peripheral surface thereof while being engaged with the outer peripheral surface of the lens housing to guide the lens housing to move along the movement axis.

13. The optical zoom apparatus as claimed in claim 12, wherein each guide device comprises:
a guide groove formed on the inner peripheral surface of the nonmagnetic body;
an elastic means inserted into the guide groove; and
a guide ball inserted into the guide groove in such a manner that a portion thereof contacts the outer periphery of the lens housing to be forced against the outer peripheral surface of the lens housing by an elastic force from the elastic means.

14. The optical zoom apparatus as claimed in claim 11, wherein the nonmagnetic body comprises a plurality of guide blades extending along the periphery of the C-grooves in a direction perpendicular to the movement axis and each coil group surrounds the periphery of the corresponding guide blade.

15. The optical zoom apparatus as claimed in claim 5, wherein a surface of the third magnetic body has the same polarity with that of surfaces of the first and second magnetic bodies, which face the surface of the third magnetic body, and the first and second magnetic bodies maintain a spacing from an optical tube by means of the third magnetic body.

16. The optical zoom apparatus as claimed in claim 1, wherein surfaces of the first and second magnetic bodies facing each other have the same polarity and the first and second magnetic bodies have a radial structure with a hollow formed at the center thereof along the movement axis.

17. The optical zoom apparatus as claimed in claim 1, wherein said optical zoom apparatus further comprises an external housing having a cylindrical shape with a hollow extending through the center thereof along the movement axis, wherein the plurality of lenses, lens housing, first and second magnetic body and movement means are mounted in the hollow, and the first and second magnetic bodies are supported on the inner peripheral surface of the external housing.

18. A portable communication apparatus comprising:
an optical zoom camera lens module, the optical zoom camera lens module including,
a plurality of lenses;
a lens housing for retaining the plurality of lenses;
a first magnetic body positioned near the lens housing;
a second magnetic body positioned near the lens housing along a movement axis while being spaced from the first magnetic body; and
a movement means positioned between the first and second magnetic bodies to move the lens housing along the movement axis as an electric current is applied.

19. The portable communication apparatus as claimed in claim 18, wherein the movement means comprises:
a DC power source to provide the movement means with a direct current and
a variable potentiostat to control the intensity and direction of the direct current provided to the movement means.

20. The portable communication apparatus as claimed in claim 18, wherein the movement means comprises a solenoid.
